(19) United States
(12) Patent Application Publication
(10) Pub. No.: US 2017/0286053 A1
(43) Pub. Date: Oct. 5, 2017

(54) SYSTEM AND METHOD FOR REAL-TIME ADJUSTMENT OF VOLUME DURING LIVE BROADCASTING

(71) Applicants: Le Holdings(Beijing)Co., Ltd., Beijing (CN); Le Cloud Computing Co., Ltd., Beijing (CN)

(72) Inventors: Maosheng BAI, Beijing (CN); Wei WEI, Beijing (CN); Hai QI, Beijing (CN)

(21) Appl. No.: 15/246,205

(22) Filed: Aug. 24, 2016

Related U.S. Application Data
(63) Continuation of application No. PCT/CN2016/088987, filed on Jul. 6, 2016.

(30) Foreign Application Priority Data
Mar. 30, 2016 (CN) 201610195335.2

(51) Int. Cl. G06F 3/16; H04L 29/06; G10L 19/16

(52) U.S. Cl. CPC G06F 3/165; G10L 19/173; H04L 65/4076; H04L 65/601; H04L 65/607

(57) ABSTRACT

The disclosure discloses a system and method for real-time adjustment of a volume during live broadcasting, the system being arranged in a live broadcasting backend, wherein the system includes a transcoder and a volume adjusting device, wherein the transcoder includes a decoding unit and an encoding unit, wherein the decoding unit is configured to decode in real time a live broadcasting audio and video uploaded to the live broadcasting backend into original audio and video signals; and the encoding unit is configured to encode in real time the original audio and video signals into encoded audio and video signals; and the volume adjusting device is arranged between the decoding unit and the encoding unit, and configured to adjust the volume of the original audio signal output by the decoding unit to the encoding unit, in response to a volume adjusting instruction.

### CROSS REFERENCE TO RELATED APPLICATIONS

This application is a continuation of International Application No. PCT/CN2016/088987, filed on Jul. 6, 2016, which is based upon and claims priority to Chinese Patent Application No. 201610195335.2, filed on Mar. 30, 2016, the entire contents of which are incorporated herein by reference.

### TECHNICAL FIELD

The present disclosure relates to the field of video transmission over a network, and applications thereof, and particularly to a system and method for real-time adjustment of a volume during live broadcasting.

### BACKGROUND

A live broadcasting over a network enables a user to watch a remote live scene ongoing on the spot over the network, where audio and video contents on the spot which are watched by the user are referred to as live audios and videos.

In the prior art, a network broadcaster acquires audios and videos using a live stream pushing software, for example, an Open Broadcaster Software (OBS), on a Personal Computer (PC), a mobile phone, or another intelligent electronic device, encodes in real time the acquired audios and videos, and transmits the encoded live audios and videos to a live broadcasting server (a live broadcasting backend). Audience transmit a request to the live broadcasting server to watch the live audios and videos, and the live broadcasting server transcodes in real time the live audios and videos available from the network broadcaster, and transmits the transcoded audios and videos to terminal devices of the audience. The live broadcasting server transcodes the live audios and videos essentially by firstly decoding and then encoding them primarily for the purpose of keeping them consistent with audio and video encoding formats of the terminal devices of the audience, and of adapting them to different network bandwidths, different terminal processing capacities, and different user demands

While the network broadcaster is acquiring the audios and videos, the volume of an audio signal acquired by a limiting acquiring device may not be appropriate, so the volume of the audio signal to be played to the user on the terminal needs to be manually adjusted locally, thus reducing the experience of the user. Moreover for the sake of more satisfaction of the user, a live broadcasting operator may also need to adjust the volume of a live broadcasting stream to be transmitted to the user, typically by breaking and pushing again the stream.

### SUMMARY

An object of the disclosure is to provide an innovative technical solution to real-time adjustment of a volume during live broadcasting.

According to an embodiment of the disclosure provides a system for real-time adjustment of a volume during live broadcasting, the system being arranged in a live broadcasting backend, wherein the system includes a transcoder and a volume adjusting device, wherein the transcoder includes a decoding unit and an encoding unit, wherein the decoding unit is configured to decode in real time a live broadcasting audio and video uploaded to the live broadcasting backend into original audio and video signals; and the encoding unit is configured to encode in real time the original audio and video signals into encoded audio and video signals; and the volume adjusting device is arranged between the decoding unit and the encoding unit, and configured to adjust the volume of the original audio signal output by the decoding unit to the encoding unit, in response to a volume adjusting instruction.

Preferably the system further includes a monitoring interface, and the volume adjusting device monitors via the monitoring interface a volume adjusting instruction transmitted by a content provider and/or a live broadcasting operation and maintenance system.

Preferably the original audio signal is a PCM signal, and the volume adjusting device is an amplitude adjusting device.

Preferably the system further includes a volume detecting device configured to detect that whether such an amplitude of the original audio signal output by the decoding unit lies in certain interval, and if the amplitude outside of the interval is detected, then the volume detecting device instructs the volume adjusting device to adjust the amplitude of the original audio signal output by the decoding unit to the encoding unit within the interval.

Preferably the system further includes an adaptive denoising circuit configured to denoise the original audio signal volume-adjusted.

According to a second aspect of the disclosure, there is further provided a live broadcasting backend including the system for real-time adjustment of a volume during live broadcasting according to any one of the embodiments above.

According to a third aspect of the disclosure, there is further provided a method for real-time adjustment of a volume during live broadcasting, the method being performed at a live broadcasting backend, wherein the method includes the following operations of: the operation S1 of decoding in real time a live broadcasting audio and video uploaded to the live broadcasting backend into original audio and video signals; the operation S2 of adjusting the volume of the original audio signal in response to a volume adjusting instruction; the operation S3 of encoding in real time the original video signal, and the volume-adjusted original audio signal; and the operation S4 of transmitting the audio and video signals encoded to a terminal device.

Preferably the method further includes the operation of mointoring a volume adjusting instruction transmitted by a content provider and/or a live broadcasting operation and maintenance system, and if a volume adjusting instruction is monitored, then the operation S2 is performed.

Preferably if the original audio signal is a PCM signal, then the amplitude of the original audio signal is adjusted in response to the volume adjusting instruction in the operation S2.

Preferably between the operation S2 and the operation S3, the method further includes the operation S21 of adaptively denoising the original audio signal volume-adjusted.

The technical solutions according to the embodiments of the disclosure can adjust in real tome the volume at the source end during the live broadcasting over a network to thereby provide a user with a better experience. The technical solutions according to the embodiments of the disclosure can adjust in real time the volume for a number of times while transcoding in real time at the source end without interrupting the stream.

Other features of the disclosure and their advantages will become apparent from the following detailed description of exemplary embodiments of the disclosure with reference to the drawings.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a block diagram of a system for real-time adjustment of a volume during live broadcasting in accordance with some embodiments;

FIG. 2 illustrates a block diagram of a system for real-time adjustment of a volume during live broadcasting in accordance with some embodiments;

FIG. 3 illustrates a flow chart of a method for real-time adjustment of a volume during live broadcasting in accordance with some embodiments; and

FIG. 4 illustrates a block diagram of hardware configuration of a live broadcasting backend in accordance with some embodiments.

### DETAILED DESCRIPTION

Various exemplary embodiments of the disclosure will be described below in details with reference to the drawings. It shall be noted that unless stated otherwise, relative arrangements of components and operations, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

Referring to FIG. 1 illustrating a system for real-time adjustment of a volume during live broadcasting according to a first embodiment of the disclosure, the system is arranged in a live broadcasting backend.

A transcoder of the live broadcasting backend includes a decoding unit 1 and an encoding unit 3, where the decoding unit 1 is configured to decode in real time a live broadcasting audio and video uploaded to the live broadcasting backend into original audio and video signals; and the encoding unit 3 is configured to encode in real time the original audio and video signals into encoded audio and video signals for transmission by the live broadcasting backend to terminal devices of audience.

A volume adjusting device 2 is arranged between the decoding unit 1 and the encoding unit 3, and configured to adjust the volume of the original audio signal output by the decoding unit 1 to the encoding unit 3, in response to a volume adjusting instruction.

Here if the decoding unit 1 outputs the original audio signal in the Pulse Code Modulation (PCM) format, then the volume adjusting unit 2 can be an amplitude adjusting device, for example.

Here the system further includes an adaptive denoising circuit configured to denoise the original audio signal volume-adjusted, and to input the original audio signal denoised to the encoding unit 3.

Here the system can be provided with a reserved monitoring interface accessible to OBS software of a network broadcaster, or an operation and maintenance person of the live broadcasting backend. The volume adjusting device 2 monitors via the listsener interface a volume adjusting instruction transmitted by a content provider and/or a live broadcasting operation and maintenance system, and upon monitor of a volume adjusting instruction, the volume adjusting device 2 adjusts the volume of the original audio signal output by the decoding unit 1 to the encoding unit 3, in response to the volume adjusting instruction.

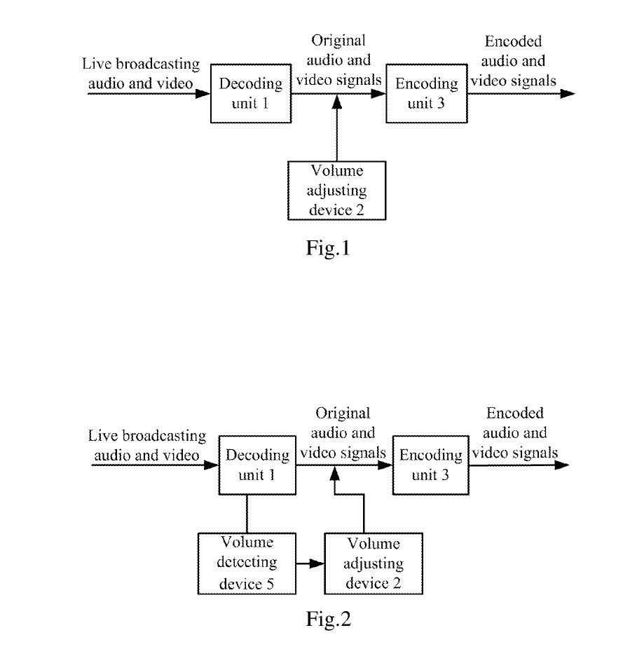

Referring to FIG. 2 illustrating a system for real-time adjustment of a volume during live broadcasting according to a second embodiment of the disclosure, the system is arranged in a live broadcasting backend.

A transcoder of the live broadcasting backend includes a decoding unit 1 and an encoding unit 3, where the decoding unit 1 is configured to decode in real time a live broadcasting audio and video uploaded to the live broadcasting backend into original audio and video signals; and the encoding unit 3 is configured to encode in real time the original audio and video signals into encoded audio and video signals for transmission by the live broadcasting backend to terminal devices of audience.

A volume adjusting device 2 is arranged between the decoding unit 1 and the encoding unit 3, and configured to adjust the volume of the original audio signal output by the decoding unit 1 to the encoding unit 3, in response to a volume adjusting instruction.

The system further includes a volume detecting device 5 configured to detect that whether such an amplitude of the original audio signal output by the decoding unit 1 lies in certain interval, and if the amplitude outside of the interval is detected, then the volume detecting device 5 instructs the volume adjusting device 2 to adjust the amplitude of the original audio signal output by the decoding unit 1 to the encoding unit 3 within the interval.

For example, if the interval is from 20 to 80, then if the volume detecting device 5 detects the amplitude of the original audio signal more than 80, then it will instruct the volume adjusting device to lower the amplitude of the original audio signal output by the decoding unit 1 to the encoding unit 3 below 80; and if the volume detecting device 5 detects the amplitude of the original audio signal less than 20, then it will instruct the volume adjusting device to raise the amplitude of the original audio signal output by the decoding unit 1 to the encoding unit 3 above 20. This example is merely illustrative, and those skilled in the art can set the interval and the adjustment scheme as needed in reality.

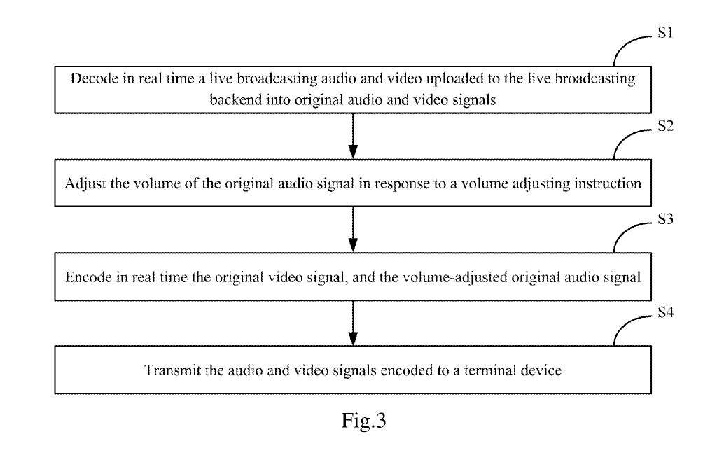

Referring to FIG. 3 illustrating a flow of a method for real-time adjustment of a volume during live broadcasting according to an embodiment of the disclosure, the method being performed at a live broadcasting backend, the method includes the following operations:

S1 is to decode in real time a live broadcasting audio and video uploaded to the live broadcasting backend into original audio and video signals;

S2 is to adjust the volume of the original audio signal in response to a volume adjusting instruction;

S3 is to encode in real time the original video signal, and the volume-adjusted original audio signal; and

S4 is to transmit the audio and video signals encoded to a terminal device.

Here the method further includes the operation of moinitoring a volume adjusting instruction transmitted by a content provider and/or a live broadcasting operation and maintenance system, and if a volume adjusting instruction is monitored, then the method will proceed to the operation S2.

Here if the original audio signal is a PCM signal, then the amplitude of the original audio signal will be adjusted in response to the volume adjusting instruction in the operation S2.

Here between the operation S2 and the operation S3, the method further includes the operation S21 of adaptively denoising the original audio signal volume-adjusted to lower noise generated as a result of adjusting the volume, and then proceeds to the operation S3.

In the technical solutions according to the embodiments of the disclosure, the volume can be adjusted while transcoding at the live broadcasting backend to thereby adjust the volume in real time without interrupting the live broadcasting so as to improve the satisfaction of the user. Preferably or optionally the disclosure can further adaptively adjust the volume of live contents.

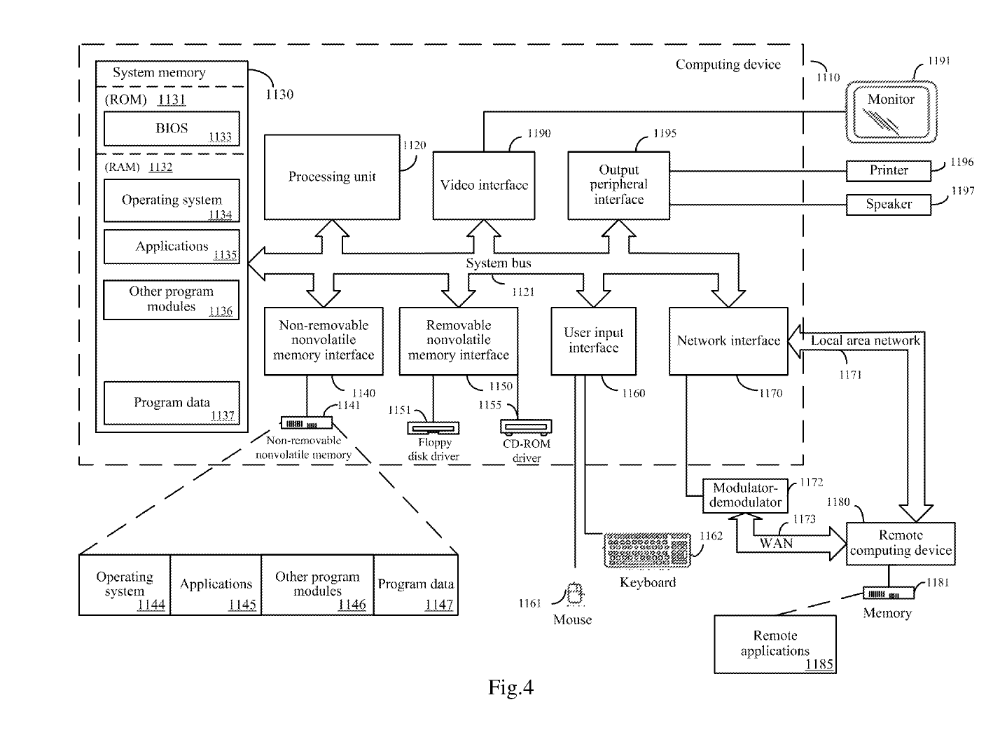

An embodiment of the disclosure further provides a live broadcasting backend including the system for real-time adjustment of a volume during live broadcasting according to any one of the technical solutions above. FIG. 4 is a block diagram showing an example of hardware configuration in which a live broadcasting backend according to an embodiment of the disclosure can be embodied.

As illustrated in FIG. 4, the live broadcasting backend includes a computing device 1110 including a processing unit 1120, a system memory 1130, a non-removable nonvolatile memory interface 1140, a removable nonvolatile memory interface 1150, a user input interface 1160, a network interface 1170, a video interface 1190, and an output peripheral interface 1195, all of which are connected over a system bus 1121.

The system memory 1130 includes a Read Only Memory (ROM) 1131 and a Random Access Memory (RAM) 1132. A Basic Input Output System (BIOS) 1133 resides in the ROM 1131. An operating system 1134, applications 1135, other program modules 1136, and some program data 1137 reside in the RAM 1132.

A non-removable nonvolatile memory 1141, e.g., a hard disk, is connected with the non-removable nonvolatile memory interface 1140. For example, the non-removable nonvolatile memory 1141 can store an operating system 1144, applications 1145, other program modules 1146, and some program data 1147.

A removable nonvolatile memory, e.g., a floppy disk driver 1151 and a Compact Disc Read Only Memory (CD-ROM) driver 1155, is connected with the removable nonvolatile memory interface 1150. For example, a floppy disk can be inserted into the floppy disk driver 1151, and a Compact Disc (CD) can be inserted into the CD-ROM driver 1155.

An input device, e.g., a mouse 1161 and a keyboard 1162, is connected with the operations management interface 1160.

The computing device 1110 can be connected with a remote computing device 1180 via the network interface 1170. For example, the network interface 1170 can be connected with the remote computing device 1180 over a local area network 1171. Alternatively the network interface 1170 can be connected with a modulator-demodulator (1172) connected with the remote computing device 1180 over a wide area network 1173.

The remote computing device 1180 can include a memory 1181 storing remote applications 1185, e.g., a hard disk.

The video interface 1190 is connected with a monitor 1191.

The output peripheral interface 1195 is connected with a printer 1196 and a speaker 1197.

FIG. 4 illustrates a live broadcasting backend which is merely illustrative but not to intend to limit the disclosure and its applications or uses.

The disclosure can be embodied as a system, a method, and/or a computer program product. The computer program product can include a computer readable storage medium on which computer readable program instructions for causing a processor to implement the respective aspects of the disclosure are carried.

The computer readable storage medium can be a tangible device which can hold and store instructions for use by an instruction executing device. The computer readable storage medium can be, for example, but will not be limited to an electronic storage device, a magnetic storage device, an optical storage device, an electromagnetic storage device, a semiconductor storage device, or any appropriate combination thereof. More particular examples (a non-exhaust listing) of the computer readable storage medium include a portable computer disk, a hard disc, a RAM, a ROM, an Erasable Programmable Read Only Memory (EPROM) or a flash memory, a Static Random Access Memory (SRAM), a CD-ROM, a Digital Versatile Disc (DVD), a memory stick, a floppy disk, a mechanically encoded device, e.g., a punched card, or a protrusion structure in a concave groove, on which instructions are stored, and any appropriate combination thereof. The computer readable storage medium as referred here to shall not be construed as an instantaneous signal per se, e.g., a radio wave, or another electromagnetic wave propagating freely, an electromagnetic wave propagating through a waveguide or another transmission medium (e.g., a light pulse propagating through an optic fiber cable), or an electronic signal transmitted over a wire.

The computer readable program instructions as referred here to can be downloaded from the computer readable storage medium to respective computing/processing devices or to external computers or external storage devices over a network, e.g., the Internet, a local area network, a wide area network and/or a wireless network. The network can include a copper transmission cable, optic fiber transmission, radio transmission, a router, a firewall, a switch, a gateway computer, and/or an edge server. A network adaptation card or a network interface in each computing/processing device receives the computer readable program instructions from the network, and forwards the computer readable program instructions for storage in the computer readable storage mediums in the respective computing/processing devices.

The computer readable program instructions for performing the operations of the disclosure can be source codes or object codes written in assembling instructions, Instruction Set Architecture (ISA) instructions, machine instructions, machine related instructions, micro codes, firmware instructions, state setting data, or any combination of one or more programming languages including an object oriented programming language, such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, an electronic circuit can be customized individually using state information of the computer readable program instructions, e.g., a programmable logic circuit, a Field programmable Gate Array (FPGA), or a Programmable Logic Array (PLA), where the electronic circuit can execute the computer readable program instructions to thereby implement the respective aspects of the disclosure.

Aspects of the present disclosure have been described here with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the disclosure is as defined in the appended claims.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A system for real-time adjustment of a volume during live broadcasting, wherein the system comprises a transcoder and a volume adjusting device, wherein:
the transcoder comprises a decoding unit and an encoding unit, wherein the decoding unit is configured to decode in real time a live broadcasting audio and video uploaded to the live broadcasting backend into original audio and video signals; and the encoding unit is configured to encode in real time the original audio and video signals into encoded audio and video signals; and
the volume adjusting device is arranged between the decoding unit and the encoding unit, and configured to adjust the volume of the original audio signal output by the decoding unit to the encoding unit, in response to a volume adjusting instruction.

2. The system according to claim 1, wherein the system further comprises a monitoring interface and the volume adjusting device monitors via the monitoring interface a volume adjusting instruction transmitted by a content provider and/or a live broadcasting operation and maintenance system.

3. The system according to claim 1, wherein the original audio signal is a Pulse Code Modulation (PCM) signal, and the volume adjusting device is an amplitude adjusting device.

4. The system according to claim 3, wherein the system further comprises a volume detecting device configured to detect that whether such an amplitude of the original audio signal output by the decoding unit lies in certain interval, and if the amplitude outside of the interval is detected, then the volume detecting device instructs the volume adjusting device to adjust the amplitude of the original audio signal output by the decoding unit to the encoding unit within the interval.

5. The system according to claim 1, wherein the system further comprises an adaptive denoising circuit configured to denoise the original audio signal volume-adjusted.

6. A live broadcasting backend, comprising a system for real-time adjustment of a volume during live broadcasting, the system being arranged in a live broadcasting backend, wherein the system comprises a transcoder and a volume adjusting device, wherein:
the transcoder comprises a decoding unit and an encoding unit, wherein the decoding unit is configured to decode in real time a live broadcasting audio and video uploaded to the live broadcasting backend into original audio and video signals; and the encoding unit is configured to encode in real time the original audio and video signals into encoded audio and video signals; and
the volume adjusting device is arranged between the decoding unit and the encoding unit, and configured to adjust the volume of the original audio signal output by the decoding unit to the encoding unit, in response to a volume adjusting instruction.

7. A live broadcasting backend according to claim 6, wherein the system further comprises a monitoring interface and the volume adjusting device monitors via the monitoring interface a volume adjusting instruction transmitted by a content provider and/or a live broadcasting operation and maintenance system.

8. A live broadcasting backend according to claim 6, wherein the original audio signal is a Pulse Code Modulation (PCM) signal, and the volume adjusting device is an amplitude adjusting device.

9. A live broadcasting backend according to claim 8, wherein the system further comprises a volume detecting device configured to detect that whether such an amplitude of the original audio signal output by the decoding unit lies in certain interval, and if the amplitude outside of the interval is detected, then the volume detecting device instructs the volume adjusting device to adjust the amplitude of the original audio signal output by the decoding unit to the encoding unit within the interval.

10. A live broadcasting backend according to claim 6, wherein the system further comprises an adaptive denoising circuit configured to denoise the original audio signal volume-adjusted.

11. A method for real-time adjustment of a volume during live broadcasting, the method being performed at a live broadcasting backend, wherein the method comprises the operations of:
the operation S1 of decoding in real time a live broadcasting audio and video uploaded to the live broadcasting backend into original audio and video signals;
the operation S2 of adjusting the volume of the original audio signal in response to a volume adjusting instruction;
the operation S3 of encoding in real time the original video signal, and the volume-adjusted original audio signal; and
the operation S4 of transmitting the audio and video signals encoded to a terminal device.

12. The method according to claim 11, wherein the method further comprises the operation of monitoring a volume adjusting instruction transmitted by a content provider and/or a live broadcasting operation and maintenance system, and if a volume adjusting instruction is monitored, then the operation S2 is performed.

13. The method according to claim 11, wherein if the original audio signal is a PCM signal, then the amplitude of the original audio signal is adjusted in response to the volume adjusting instruction in the operation S2.

14. The method according to claim 11, wherein between the operation S2 and the operation S3, the method further comprises the operation S21 of adaptively denoising the original audio signal volume-adjusted.
